(19) United States
(12) Patent Application Publication
(10) Pub. No.: US 2007/0217303 A1
(43) Pub. Date: Sep. 20, 2007

(54) Seatbelt lens control during rough seek

(75) Inventors: Chi Chan, San Jose, CA (US); Ainobu Yoshimoto, Milpitas, CA (US)

Correspondence Address: LSI CORPORATION, 1621 BARBER LANE, MS: D-106, MILPITAS, CA, 95035, US

(73) Assignee: LSI LOGIC CORPORATION

(21) Appl. No.: 11/374,763

(22) Filed: Mar. 14, 2006

(51) Int. Cl. G11B 7/00

(52) U.S. Cl. 369/44.32; 369/44.11

(57) ABSTRACT

An apparatus comprising a lens, a stepper motor and a tracking error controller. The lens may be positioned in a sled housing. The stepper motor may be configured to (i) move the sled housing in response to a first control signal and (ii) vibrate the lens in response to moving the sled housing. The tracking error controller may be configured to lock the lens to any one of a particular number of disc tracks with a voice coil motor. The voice coil motor may be configured to minimize the vibration of the lens prior to locking the lens to any one of the particular number of disc tracks.

### FIELD OF THE INVENTION

The present invention relates to optical storage generally and, more particularly, to a method and/or apparatus for implementing seatbelt lens control during a rough seek.

### BACKGROUND OF THE INVENTION

In a conventional optical disc system, to sense the position of the laser beam in relation to the track on the disc, the main laser beam creates a reflection from the disc. The reflection is typically picked up by 4 photo-diode sensors. FIG. 1 is a conceptual diagram illustrating how such a photo-diode configuration is laid out in relation to the track direction. The outputs of the 4 photo-diodes (when the laser beam is focused on the disc) are shown as signals A, B, C and D, respectively.

To control the position of a main laser beam 22 on the optical disc 23, the position of the objective lens 24 of the Optical Pickup Unit (OPU) 25 related to the tracks 26a-26n on the optical disc 23 is controlled by a voice coil motor. A tracking actuator may include the voice coil motor. The OPU 25 is a device configured to emit a laser beam 22 and pick up the optical reflection of the beam 22. The OPU 25 converts such reflections to electrical signals. The position of the lens 24 and a sled housing 28 of the OPU 25 are controlled by a stepper motor (not shown). FIG. 2 illustrates the motion of the OPU 25 and the lens 24.

Referring to FIG. 3, a conventional system illustrating the motion of the lens 24 and the sled housing 28 is shown. In a rough seek (or long seek) the sled housing 28 is moved by sled screw mechanics of the stepper motor over the tracks 26a-26. During a rough seek operation with the OPU 25, the lens 24 is attached to the sled housing 28. The lens 24 is attached to the sled housing 28 with springs 28. A spring 28 is attached to each side of the lens 24. The lens 24 has 3 degrees of freedom. During acceleration and deceleration of the sled housing 28, the lens 24 will move forward and backward due to inertia. Since a stepping motor is used to move the sled housing 32 during a rough seek, the vibration is especially prominent. Such a vibration results in a long settling time for the lens 24 to lock back to a particular one of the tracks 26a-26n after a rough seek. Such a condition will occur because a TE controller (not shown) can only measure how far off track the lens 124 is for a narrow range as compared to the vibration generated by the movement of the OPU 25 during a rough seek.

Conventional systems move the lens 24 vertically and horizontally with the voice coil motor. Such systems move a sled 32 (and the sled housing 28) slowly to avoid introducing too much vibration to the lens 24 while the lens 24 floats (i.e., no current is applied to the voice control motor and the voice coil motor exerts no control over the lens 24). After the sled 32 stops, the lens 24 floats for a period of time to allow the motion of the lens 24 to settle before the TE controller locks the lens 24 to a particular one of the tracks 26a-26n. The TE controller controls the lens 24 after a rough seek. If the on-track conditions are not met, the lens 24 floats again to allow for settling. The TE controller will attempt to lock the lens 24 to a particular one of the tracks 26a-26n.

Conventional systems also use a center error (CE) controller (not shown) to stabilize the motion of the lens 24 during movement of the sled housing 28. The CE controller stabilizes the motion of the lens 24 during settling since the CE controller can measure a further off track position than the TE controller can. After a particular one of the tracks 26a-26n is locked to the lens 24, control of the lens 24 switches from the CE controller to the TE controller.

Conventional systems result in a relatively long rough seek time and longer settling time. During a rough seek, the sled 32 is moved slowly. Upon settling, the movement of the lens 24 is volatile because the lens 24 is not under control. Therefore, the length of time needed to lock the lens 24 to a particular one of the tracks 26a-26n is increased. The TE controller can only regulate the lens for a small range and is not effective due to the larger range of motion of the sled 32 during a rough seek. The TE controller can only wait for the motion to settle down naturally.

The CE controller is controlled by a feedback signal (or signal CE). The disadvantage of using the CE controller to stabilize the motion of the lens 24 is that the signal CE has to have a good signal-to-noise ratio. If the signal CE is too noisy to provide any information about the position of the lens 24, the CE controller may drive the lens 24 into an unstable mode.

It would be desirable to provide a method and/or apparatus to provide seatbelt lens control during a rough seek.

### SUMMARY OF THE INVENTION

The present invention concerns an apparatus comprising a lens, a stepper motor and a tracking error controller. The lens may be positioned in a sled housing. The stepper motor may be configured to (i) move the sled housing in response to a first control signal and (ii) vibrate the lens in response to moving the sled housing. The tracking error controller may be configured to lock the lens to any one of a particular number of disc tracks with a voice coil motor. The voice coil motor may be configured to minimize the vibration of the lens prior to locking the lens to any one of the particular number of disc tracks.

The objects, features and advantages of the present invention include providing a method and/or apparatus that implements a seatbelt lens control during a rough seek that may (i) increase the speed of the sled, (ii) minimize the amount of vibration induced to the lens, (iii) reliably lock the lens to the track since the lens is stationery and stable enough before the lens is locked to the track, (iv) be simple to implement, (v) provide less code which is simpler to debug, and/or (vi) provide faster rough seek and settling time for the lens.

### BRIEF DESCRIPTION OF THE DRAWINGS

These and other objects, features and advantages of the present invention will be apparent from the following detailed description and the appended claims and drawings in which:

FIG. 1 illustrates a photo-diode sensor distribution system;

FIG. 2 illustrates a lens and a lens housing in relation to the position of a laser beam;

FIG. 3 illustrates the motion of a sled and the lens during a rough seek;

FIG. 4 is a diagram of a system illustrating the present invention;

FIG. 5 is a state machine of the present invention;

FIG. 6 illustrates the state of the voice coil motor digital-to-analog converter during movement of the sled housing in accordance with the present invention;

FIG. 7 is a diagram of a center error creation circuit of FIG. 4; and

FIG. 8 is a diagram of the creation circuit of the signal focusing error and the signal beam strength.

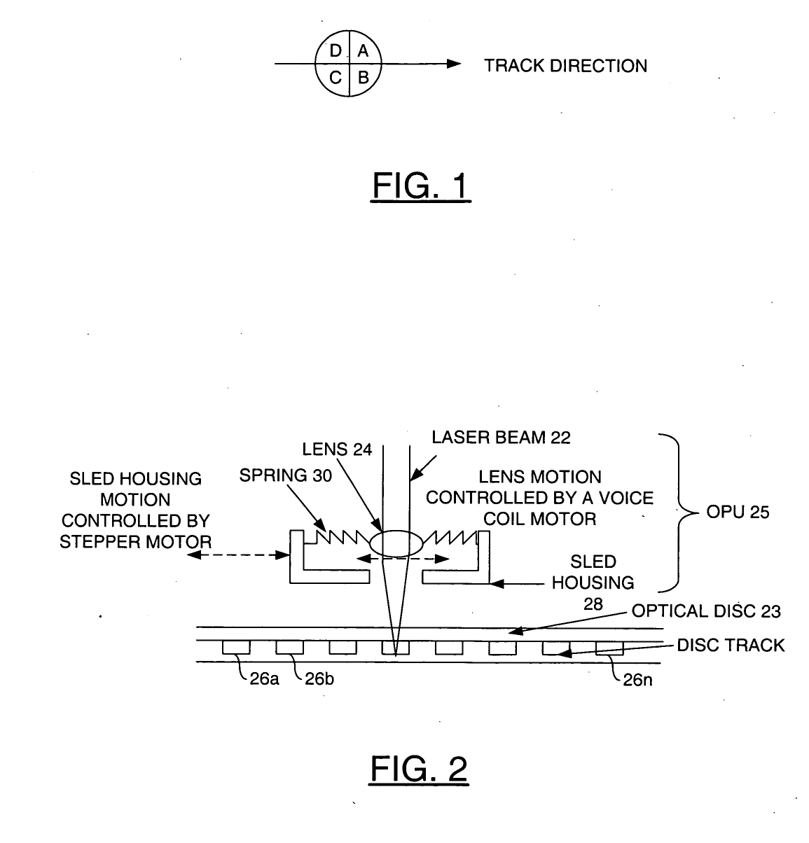

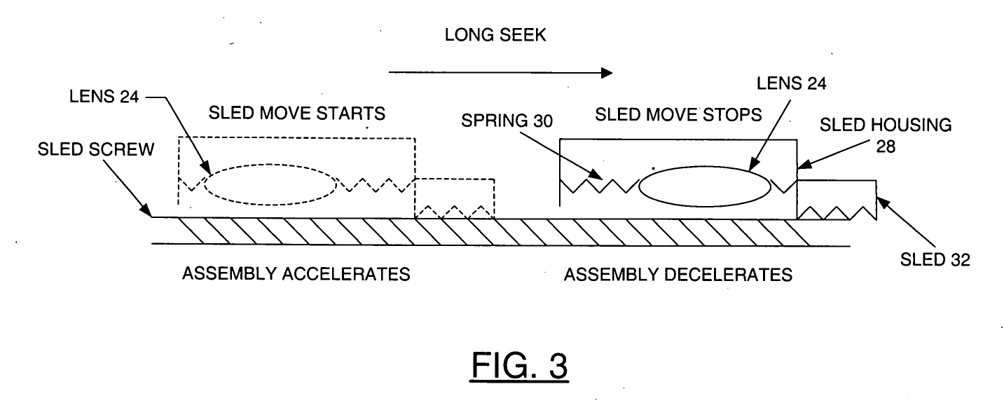

### DETAILED DESCRIPTION OF THE PREFERRED EMBODIMENTS

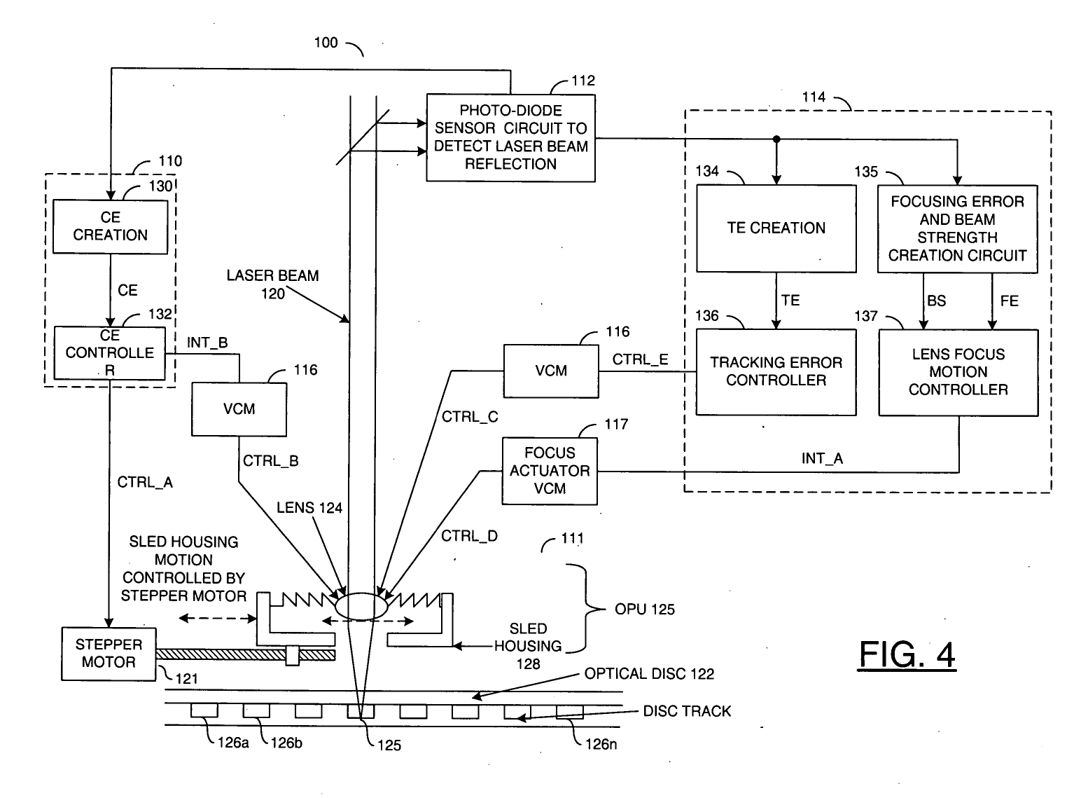

Referring to FIG. 4, a diagram of a system 100 in accordance with a preferred embodiment of the present invention is shown. The system 100 generally comprises a control circuit 110, a lens housing portion 111, a photo distribution portion 112, a control circuit 114, a voice coil motor 116, a focus actuator 117 and a sled motor 121. The focus actuator 117 may be implemented as part of the voice coil motor 116. The control circuit 110 generally comprises a block (or circuit) 130 and a block (or circuit) 132. The circuit 130 may be implemented as a center error (CE) creation circuit. The circuit 132 may be implemented as a CE controller. The lens housing portion 111 generally comprises a laser pick-up (or laser beam) 120, an optical disc 122, a lens 124, an optical pick-up unit 125, and a sled housing 128. The optical disc 122 generally comprises a number of disc tracks 126a-126n. The control circuit 114 generally comprises a block (or circuit) 134, a block (or circuit) 135, a block (or circuit) 136 and a block (or circuit) 137. The circuit 134 may be implemented as a tracking error (TE) creation circuit. The circuit 135 may be implemented as a focusing error and beam strength creation circuit. The circuit 136 may be implemented as a TE controller. The circuit 137 may be implemented as a lens focus motion controller.

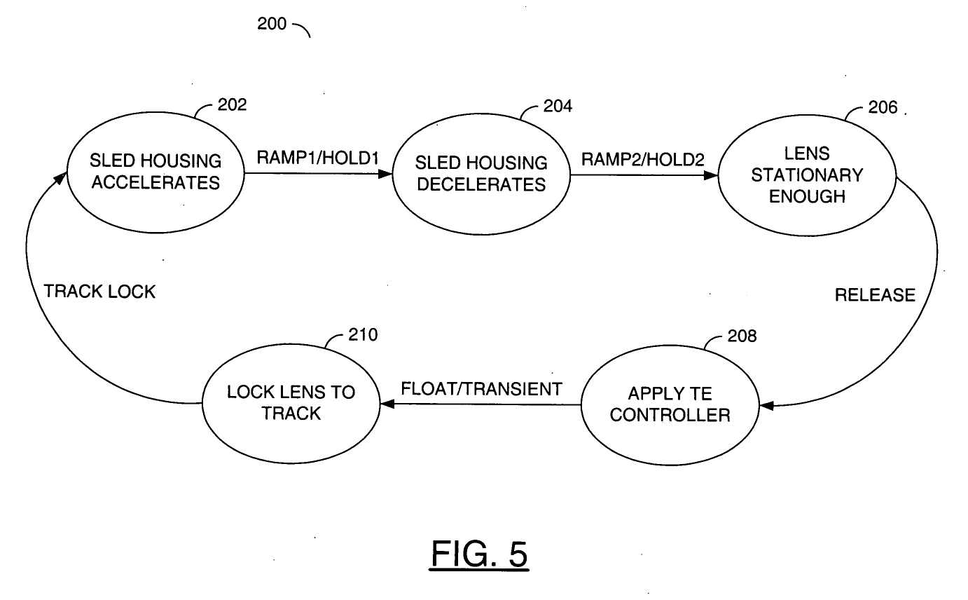

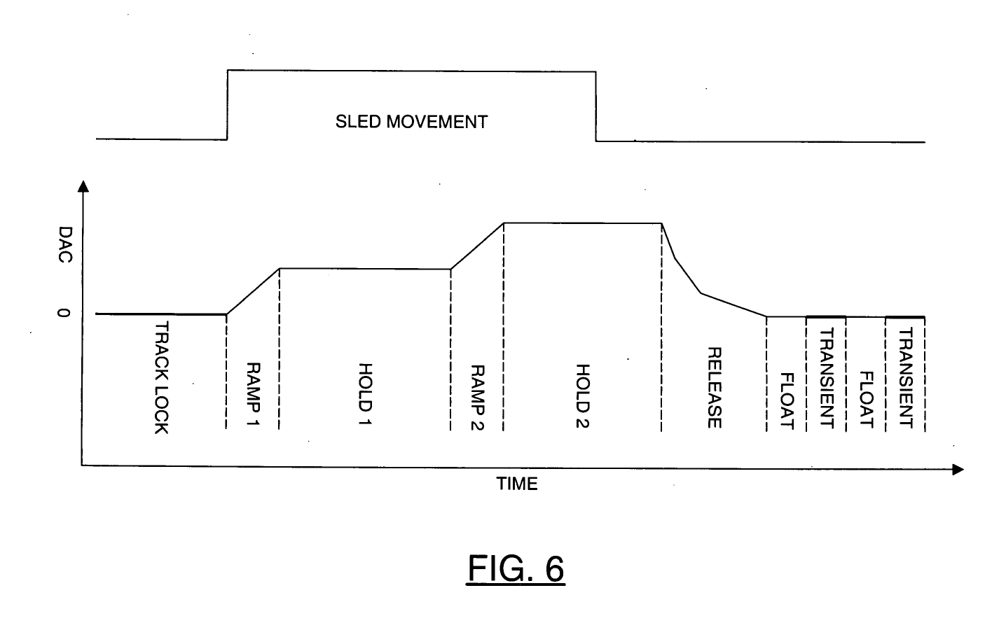

The photo distribution portion 112 may present photo-diode signals (e.g., A, B, C and D) to the control circuit 110 and the control circuit 114. The types of photo-diode signals presented to the control circuit 110 and the control circuit 114 will be discussed in more detail in connection to FIGS. 5-6. The CE creation circuit 130 may present a center error signal (or signal CE) to the CE controller 132. The CE controller 132 may present a control signal (e.g., CTRL_A) to the stepper motor 121. The CE controller 132 may control the movement of the stepper motor 121 with the signal CTRL_A. The CE controller 132 may present a signal (e.g., INT_B) to the voice coil motor 116. The CE controller 132 may control the voice coil motor 116 with the signal INT_B. The voice coil motor 116 may present a control signal (e.g., CTRL_B) to the lens 124. The voice coil motor 116 may control the position of the lens 124 with the signal CTRL_B. The focusing error and beam strength creation circuit 135 may present a signal (e.g., BS) and a signal (e.g., FS) to the lens focus motion controller 137. The signal FE may be a focusing error signal. The signal BS may be a beam strength signal. The lens focus motion controller 137 may present a signal (e.g., INT_A) to the focus actuator 117. The focus actuator 117 may present a signal (e.g., CTRL_D) to the lens 124. The focus actuator 117 may control the vertical and horizontal position of the lens 124 with the signal CTRL_D. The TE creation circuit 134 may present a signal (e.g., TE) to the TE controller 136. The TE controller 136 may present a signal (e.g., CTRL_E) to the voice coil motor 116. The TE controller 136 may control the voice coil motor 116 with the signal CTRL_E. The voice coil motor 116 may present a signal (e.g., CTRL_C) to the lens 124. The voice coil motor 116 may control the lens 124 with the signal CTRL_C. The CE controller 132 may control the voice coil motor 116 when the system 100 is performing a rough seek. The TE controller 136 may control the voice coil motor 116 when the system 100 is in a fine seek or tracking mode.

The focusing actuator 117 may move the lens 124 vertically to direct a focus point 125 of the laser beam 122 over the surface of the optical disc 122 and over a particular one of the physical tracks 126a-126n. In general, the signals FE and BS may be used to sense the lens 124 and/or the vertical position of the laser beam 120.

The system 100 may reduce the vibration of the lens 124 and allow the TE controller 136 to lock the lens 124 to a particular one of the tracks 126a-126n by performing the following steps:

In a first step, while the system 100 is in a rough seek, the lens 124 may be held while the sled housing 124 is accelerating. The voice coil motor 116 may include a digital-to-analog controller (DAC) (not shown). A DAC value of the VCM 116 may be ramped gradually to a fixed level to push the lens 124 against one side of the sled housing 128 while the sled housing 128 accelerates and/or coasts. The voice coil motor 116 may apply a fixed amount of current to push the lens 124 all the way to one end of the sled housing 128 to hold the lens 124. The direction in which the voice coil motor 116 pushes the lens 124 may depend on the direction of the sled housing 128 while the sled housing 128 is pushed during a rough seek. By pushing the lens 124 to one side of the sled housing 128, the effect of the vibration introduced by the stepping motor 121 may be minimized.

In a second step, the lens 124 may be held while the sled housing 128 decelerates. The DAC value of the VCM 116 may be ramped gradually to a higher fixed level to push the lens 124 further against one side of the sled housing 128 while the sled housing 128 decelerates. The VCM 116 may continue to push the lens 124 for a predetermined period of time until the vibration caused by the stepping motor moving the sled housing 128 dissipates. The second step may be initialized at a predetermined time before the sled housing 128 stops to allow enough time for the DAC of the VCM 116 to ramp up and hold the lens 124 at one end of the sled housing 128.

In a third step, the lens 124 may be released by the VCM 116 (e.g., after a rough seek). The VCM 116 may ramp down the DAC value exponentially to float (or cease to provide current) the lens 124 so that the lens 124 may be stationary enough to lock the lens 124 to one of the particular tracks 126a-126n with the track TE controller 136. A repeatable run out circuit (not shown) in the CE controller 132 may move the lens 24 (or center the lens 124 in the presence of run out) to compensate for the eccentricity of the tracks 126a-126n prior to locking the lens 124.

In a fourth step, the lens 124 may be float and is checked to determine if the movement of the lens 124 is slow enough to apply the TE controller 136 in a transient state. A predetermined amount of time may determine how long the TE controller 136 is in a transient state. In order to determine if the lens 124 is locked to a particular one of the tracks 126a-126n, the system 100 may perform a half track check, a signal TE check, and/or a signal FE check. The system 100 may also ensure that the lens 124 is locked to a particular one of the tracks 126a-126n with the following equation:
Moving average (DEV²(BS))=Moving average ((instantaneous BS−moving average(BS))²)<predefined constant, where DEV is defined as the deviation of the signal BS (or DEV(BS)=| B̅S̅−BS|). EQ1

EQ1 may ensure that the vertical motion of the lens 124 is stationary enough to be locked to a particular one of the tracks 126a-126n with the TE controller 136.

Referring to FIG. 5, a state machine illustrating the present invention is shown. The state machine 200 generally comprises a state 202, a state 204, a state 206, a state 208 and a state 210. In the state 202, the sled housing 128 may accelerate while the system 100 is in a rough seek. The DAC value of the voice coil motor 116 may initially ramp up to a first ramp level (e.g., RAMP1) and be held to a first hold level (e.g., HOLD1). The voice coil motor 116 may gradually push and hold the lens 124 against one side of the sled housing 128.

The state machine 200 may move to the state 204 when the sled housing 204 decelerates. In the state 204, the DAC value of the voice coil motor 116 may ramp up to a second ramp level (e.g., RAMP2) and be held to a second hold level (e.g., HOLD2). The voice coil motor 116 may push the lens 124 further against one side of the sled housing 128 as the sled housing 128 decelerates.

The state machine 200 may move to the state 206 when the lens 124 is determined to be stationary enough to lock to one of the particular tracks 126a-126n. In the state 206, the voice coil motor 116 may release the lens 124 at an exponential rate to a level (e.g., RELEASE) when the lens 124 is determined to be stationary enough. The state machine 200 may move to the state 208 to apply the TE controller 136. The state 208 may ensure that the vertical motion of the lens 124 is stationary enough to lock the lens 124 to a particular one of the tracks 126a-126n. The DAC value of the voice coil motor 116 may be held to a level (e.g., FLOAT and TRANSIENT).

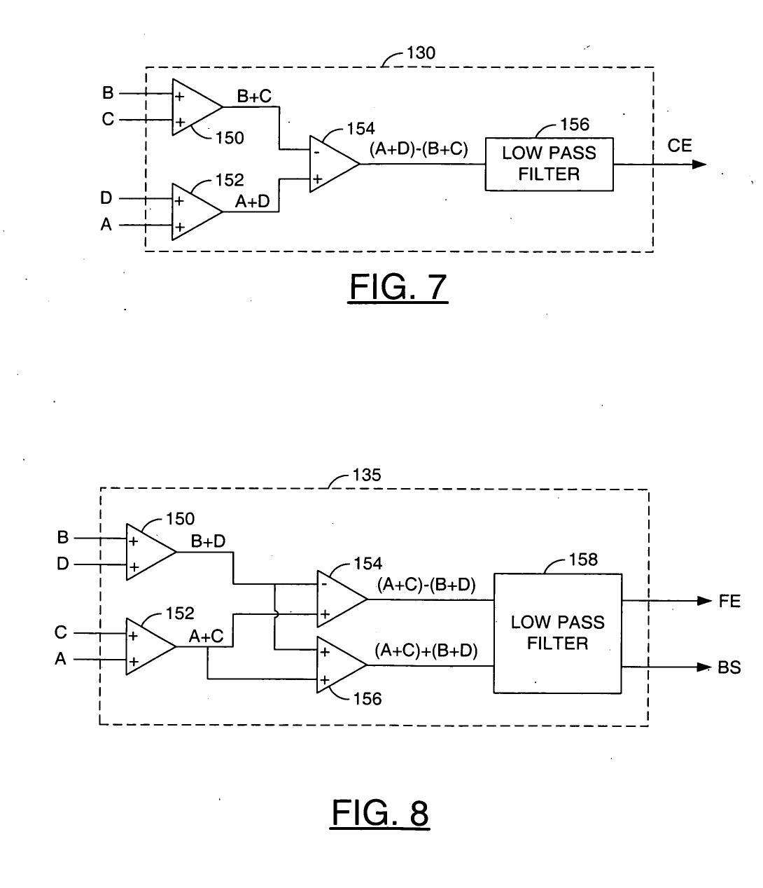

The state machine 200 may move to the state 210 to lock the lens 124 to a particular one of the tracks 126a-126n. In the state 210, the TE controller 136 may lock the lens 124 to one of the particular tracks 126a-126n. The DAC value may remain at the level FLOAT and the level TRANSIENT. FIG. 7 generally illustrates the DAC values of the voice coil motor 116 at various levels in accordance to the state machine 200.

Referring to FIG. 7, a more detailed diagram of the CE creation block 130 is shown. The CE creation block 130 generally comprises a block (or circuit) 150, a block (or circuit) 152, a block (or circuit) 154 and a block (or circuit) 156. The circuit 150 and the circuit 152 may be implemented as summing circuits. The circuit 154 may be implemented as a differential circuit (e.g., a comparator, etc.). The circuit 156 may be implemented as a low pass filter. In general, the circuit 150 receives the signal B and the signal C and presents a signal equal to B+C. Similarly, the circuit 152 receives the signal A and the signal D and presents an output signal equal to A+D. The signals A, B, C and D may be presented by the photo-diode sensor circuit 112. The differential circuit 154 receives the signal B+C and the signal A+D and presents a signal equal to (A+D)−(B+C). The signal (A+D)−(B+C) is presented to the low pass filter 156, which generates the signal CE.

The tracking error signal TE is a signal created by either a differential phase detecting (DPD) method or a differential push pull (DPP) method. With the DPD method, the difference in phase of two signals (A+C) and (B+D) is used to create the signal TE. In the DPP method, the difference in value of two signals (A+D) and (B+C) is used to create the signal TE. Either method detects the position of the laser beam 120 in relation to the tracks 126a-126n on the disc 122. When the signal TE is properly generated, if the laser beam 120 is staying (or “locked”) on a particular one of the tracks 126a-126n, then the signal TE may have a small change in value. If the laser beam 122 is moving across the tracks 126a-126n, then the signal TE will vary from peak to bottom. The center value of this variation may be the value of the signal TE when the beam 120 is staying on a particular one of the tracks 126a-126n.

Referring to FIG. 8, a more detailed diagram of the focus error and beam creation circuit 135 is shown. The creation circuit 135 generally comprises a circuit 150, a circuit 152, a circuit 154, a circuit 156 and a circuit 158. The circuit 150, the circuit 152 and the circuit 156 may be implemented as summing circuits. The circuit 154 may be implemented as a differential circuit (e.g., a comparator, etc.). The circuit 158 may be implemented as a low pass filter. In general, the circuit 150 receives the signal B and the signal D and presents a signal equal to B+D. Similarly, the circuit 152 receives the signal A and the signal C and presents an output signal equal to A+C. The differential circuit 154 receives the signal A+C and the signal B+D and presents a signal equal to (A+C)−(B+D). The signal (A+C)−(B+D) may be presented to the low pass filter 158, which generates the signal FE. The summing circuit 156 receives the signal (A+C) and the signal (B+D) and presents a signal equal to (A+C)+(B+D). The signal (A+C)+(B+D) may be presented to the low pass filter 158, which generates the signal BS.

The present invention may (i) minimize vibration induced to the lens 124 by the movement of the sled housing 128, (ii) allow the sled housing 128 to move at increased speeds, (iii) successfully allow the TE controller 136 to lock the lens 124 to a particular one of the tracks 126a-126n and (iv) provide fewer retries and less recovery time during track lock. The present invention may (i) be easily implemented, (ii) be easy to debug, (iii) need less coding, (iv) provide a fast long seek and settle time, and/or (v) need less seek failure and recovery.

The function performed by the state machine of FIG. 5 may be implemented using a conventional general purpose digital computer programmed according to the teachings of the present specification, as will be apparent to those skilled in the relevant art(s). Appropriate software coding can readily be prepared by skilled programmers based on the teachings of the present disclosure, as will also be apparent to those skilled in the relevant art(s).

The present invention may also be implemented by the preparation of ASICs, FPGAs, or by interconnecting an appropriate network of conventional component circuits, as is described herein, modifications of which will be readily apparent to those skilled in the art(s).

The present invention thus may also include a computer product which may be a storage medium including instructions which can be used to program a computer to perform a process in accordance with the present invention. The storage medium can include, but is not limited to, any type of disk including floppy disk, optical disk, CD-ROM, magneto-optical disks, ROMs, RAMs, EPROMs, EEPROMS, Flash memory, magnetic or optical cards, or any type of media suitable for storing electronic instructions.

While the invention has been particularly shown and described with reference to the preferred embodiments thereof, it will be understood by those skilled in the art that various changes in form and details may be made without departing from the scope of the invention.

1. An apparatus comprising:
a lens positioned in a sled housing;
a stepper motor configured to (i) move said sled housing in response to a first control signal and (ii) vibrate said lens in response to moving said sled housing; and
a tracking error controller configured to lock said lens to any one of a particular number of disc tracks with a voice coil motor, wherein said voice coil motor is configured to minimize the vibration of said lens prior to locking said lens to said one of a particular number of disc tracks.

2. The apparatus according to claim 1, wherein said voice coil motor minimizes the vibration of said lens when said apparatus is performing a rough seek.

3. The apparatus according to claim 2, wherein said voice coil motor is configured to push said lens towards one side of said sled housing when said sled housing is accelerating prior to locking said lens.

4. The apparatus according to claim 3, wherein said voice coil motor is configured to hold said lens on said one side of sled housing after pushing said lens and when said sled housing is accelerating prior to locking said lens.

5. The apparatus according to claim 4, wherein said voice coil motor is configured to push said lens further against one side of the sled housing during the deceleration of said sled housing prior to locking said lens.

6. The apparatus according to claim 5, wherein said voice coil motor is configured to hold said lens against said sled housing for a predetermined amount of time prior to locking said lens, wherein said predetermined amount of time is longer than the amount of time said lens vibrates.

7. The apparatus according to claim 6, wherein said voice coil motor is configured to allow said lens to float to ensure that said lens is substantially stationary prior to locking said lens.

8. The apparatus according to claim 7, further comprising:
a center error controller configured to center said lens to compensate for the eccentricity of any one of said particular number of disc tracks during a rough seek.

9. The apparatus according to claim 8, wherein said voice coil motor is configured to check said lens to determine if the movement of said lens is slow enough in order to lock said lens.

10. An apparatus comprising:
means for positioning a lens in a sled housing;
means for moving said sled housing in response to a first control signal;
means for vibrating said lens in response to said means for moving said sled housing;
means for locking said lens to any one of a particular number of disc tracks; and
means for minimizing the vibration of said lens prior to said means for locking said lens to said one of a particular number of disc tracks.

11. A method for controlling the vibration of a lens in an optical disc system, said method comprising the steps of:
(A) positioning said lens in a sled housing;
(B) moving said sled housing in response to a first control signal;
(C) vibrating said lens in response to moving said sled housing;
(D) locking said lens to any one of a particular number of disc tracks; and
(E) minimizing the vibration of said lens prior to performing step (D).

12. The method according to claim 11, wherein step (E) further comprises the step of:
performing a rough seek.

13. The method according to claim 12, wherein step (E) further comprises the step of:
pushing said lens towards one side of said sled housing when said sled housing is accelerating prior to performing step (D).

14. The method according to claim 13, further comprising the step of:
holding said lens on one side of sled housing when said sled housing is accelerating prior to performing step (D).

15. The method according to claim 14, further comprising the step of:
pushing said lens further against one side of the sled housing during the deceleration of said sled housing prior to performing step (D).

16. The method according to claim 15, further comprising the step of:
holding said lens for a predetermined amount of time against said sled housing, wherein said predetermined amount of time is longer than the amount of time the lens vibrates prior to performing step (D).

17. The method according to claim 16, further comprising the step of:
allowing said lens to float to ensure that said lens is substantially stationary prior to performing step (D).

18. The method according to claim 17, further comprising the step of:
centering said lens to compensate for the eccentricity of any one of said particular number of disc tracks.

19. The method according to claim 18, further comprising the step of:
checking said lens to determine if the movement of said lens is slow enough prior to performing step (D).
